(19) United States
(12) Patent Application Publication
(10) Pub. No.: US 2007/0005482 A1
(43) Pub. Date: Jan. 4, 2007

(54) Technique for providing a personalized auction service through an information assistance provider

(76) Inventor: Andrew P. Graham, Beaverton, OR (US)

Correspondence Address: ALEX L. YIP;c/o Kaye Scholer LLP, 425 Park Avenue, New York, NY, 10022, US

(21) Appl. No.: 11/170,310

(22) Filed: Jun. 29, 2005

(51) Int. Cl. G06Q 40/00

(52) U.S. Cl. 705/37

(57) ABSTRACT

To provide a personalized auction service, data pertaining to one or more of a user's accounts with different online auction service providers (OASPs), e.g., URLs of the OASPs and account access data, is maintained in a folder by an information assistance service, which is unaffiliated with the OASPs. When the user calls the information assistance service, the user's folder is retrieved. The user's OASP accounts may be accessed on behalf of the user based on the URLs of the OASPs and account access data in the user's folder. An information assistance provider including, e.g., an operator and/or a voice server, may obtain from the OASPs information associated with the user's accounts, which may concern an auction of an item desired by the user, and communicate the same to the user. The information assistance provider may participate in one such auction on behalf of the user.

### FIELD OF THE INVENTION

The invention relates to a communications system and method, and more particularly to a system and method for enabling a user of an information assistance service to access information provided by on-line auction services.

### BACKGROUND OF THE INVENTION

In this information age, people need to be well informed and organized to effectively carry out day-to-day activities, especially when they are traveling and away from their “home” base where they normally conduct their business. As a result, use of mobile devices which facilitate mobile communications, such as wireless telephones, is ubiquitous.

Wireless phones conveniently allow users while traveling to call and communicate with other people. In case a user cannot remember the telephone number of a contact or it is not handy, or the user wants to obtain directions and other information concerning, e.g., restaurants, theaters, etc., he/she can call an information assistance provider for assistance which includes, e.g., an operator, a voice server, etc. To that end, an expansive network of communication call centers has been established which provides users with nationwide assistance.

With the advent of Internet technology, Internet-based marketplaces for the sale of goods and services have been developed by companies like eBay Inc., Yahoo! Inc., etc. These companies typically offer a website through which buyers and sellers browse, buy and sell, in the form of an auction, various items including trading cards, antiques, dolls, housewares, used cars, clothing, books, electronics, etc. For example, the eBay auction service permits sellers to list items for sale, buyers to bid on items of interest, and all users to browse through listed items online. It also offers online payment services to facilitate consummation of transactions.

An online auction service typically requires a user to register with the service. The user may be identified by his/her user ID and password. An online buyer bidding for a listed item may opt for use of one of the bidding methods including, e.g., “straight bidding,” and “automatic bidding,” also known as “proxy bidding.” In straight bidding, the buyer enters the exact amount he/she wishes to bid as if he/she were at a live auction. In automatic bidding, the buyer enters the maximum price he/she is willing to bid, and the auction system places bids for the buyer until the bid reaches the maximum price. Each bid amount is increased incrementally only as necessary to win the auction.

### SUMMARY OF THE INVENTION

The invention is premised upon the recognition that in prior art, tracking the progresses of multiple simultaneous online auctions at times can be unmanageable especially when the auctions take place at different websites. The prior art automatic bidding method may alleviate a user from constantly monitoring an auction otherwise required using the straight bidding method. However, a user employing the automatic bidding method may still want to monitor an auction from time to time in case other buyers outbid the user's maximum price and the user wants to increase the maximum price to further compete. Monitoring and participating in multiple simultaneous auctions become increasingly cumbersome as the number of auctions and the number of different websites at which the auctions take place go up, and more so if for whatever reasons the Internet access is not readily available to the user. The invention enables a user to communicate with (e.g., by calling) an information assistance provider to receive information concerning statuses of online auctions by different online auction service providers (OASPs) with which the user has registered and established an account. These OASPs are unaffiliated with the information assistance provider. In accordance with the invention, data concerning access to one or more auction accounts associated with a user is stored and may be maintained by the inventive service. When a communication from the user is received by an information assistance provider through a first communications connection, the data is retrieved and used to access the one or more auction accounts over a second communications connection. Information associated with the one or more auction accounts is then provided to the user. One or more operations with respect to an auction are performed through the second communication connection on behalf of the user. For example, upon request by the user, the information assistance provider may place a bid in the auction for the user.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates a communications system including information/call centers, in accordance with the invention;

FIGS. 2A and 2B are block diagrams of components of the communications system of FIG. 1;

FIG. 3 is a block diagram of a personalized online auction service (POAS) gateway in the communications system of FIG. 1;

FIG. 4 is a flowchart depicting a routine for eliciting from a user information for establishing the POAS, in accordance with the invention;

FIG. 5 illustrates a record maintained in a user's POAS folder, in accordance with the invention;

FIG. 6 illustrates a Login graphical user interface (GUI) for providing the POAS, in accordance with the invention;

FIG. 7 is a flowchart depicting a routine for obtaining information concerning a user's accounts with different online auction service providers, in accordance with the invention;

FIG. 8 illustrating a Listing GUI containing any bidding and tracking lists of auction items, in accordance with the invention; and

FIG. 9 illustrates an Auction Status GUI containing information concerning an auction of an item selected from a bidding list, in accordance with the invention.

### DETAILED DESCRIPTION

The invention is directed to providing personalized information and communications services to users, e.g., telephone and mobile device users. One of these services is a personalized online auction service (POAS) in accordance with the invention, which allows a user to, among others, track progresses of, and participate in, auctions on different auction websites (e.g., ebay.com, yahoo.com, etc.) through an information assistance service. The invention is premised upon the recognition that in prior art, tracking progresses of, and participating in, multiple simultaneous online auctions at times can be unmanageable especially when the auctions take place at different websites. The prior art automatic bidding method may alleviate a user from constantly monitoring an auction otherwise required using the straight bidding method. However, a user employing the automatic bidding method may still want to monitor an auction from time to time in case other buyers outbid the user's maximum price and the user wants to increase the maximum price to further compete. Monitoring and participating in multiple simultaneous auctions become increasingly cumbersome as the number of auctions and the number of different websites at which the auctions take place go up, and more so if for whatever reasons the Internet access is not readily available to the user.

The inventive POAS enables a user to communicate with (e.g., by calling) an information assistance provider to receive information concerning statuses of online auctions by different online auction service providers (OASPs) with which the user has registered and established an account. These OASPs are unaffiliated with the information assistance provider. The user's OASP account information, e.g., logins (user IDs and passwords) for different OASPs, may be maintained by the information assistance provider in an “POAS folder” associated with the user. Through the information assistance provider, a POAS user may review items in his/her “bidding” and “tracking” lists, place bids, etc. For example, a user may call the information assistance service to request to check his/her current tracking and bidding lists for the current high bids on the listed items and time remaining in each auction. The user may place a bid either through an automated system (e.g., a voice server) or with assistance from an operator with the information assistance service. Bids may be confirmed through a security check set up by the user with the information assistance service which may require the user to provide, e.g., a voiceprint sample, a PIN, or other security measures for verification of the user's identity. In addition, the information assistance service may keep a log of transactions to ensure that the user did, in fact, pass the security check to initiate a bid on an item.

To facilitate tailoring the information assistance service to individuals' needs, one or more folders are maintained for a user, based on which the service is rendered to the user. For example, as disclosed in copending, commonly assigned U.S. application Ser. No. 09/865,230, filed on May 25, 2001, incorporated herein by reference, contacts folders and appointment folders may be created and maintained to store a user's contacts and appointments information, respectively. In addition, in accordance with an aspect of the invention, a POAS folder may be created and maintained to store a user's online auction service information, e.g., data pertaining to one or more OASP accounts that the user wishes to access via the information assistance service. Such accounts were previously established by the user with such OASPs as eBay Inc., Yahoo! Inc., etc., which are unaffiliated with the present information assistance service provider. With the POAS folder in place, when the user accesses, e.g., by calling, the information assistance service, the user may be informed of items in any bidding and tracking lists associated with his/her OASP accounts, progresses of auctions of those items, and time remaining in the auctions. In addition, the user may request the information assistance provider (e.g., an operator or a voice server) to participate and bid in one or more auctions on behalf of the user if the user has not done so, or to submit a bid on behalf of the user if the user has been participating in one or more auctions. The user may also request that the POAS alert, e.g., via telephone, email, SMS, etc., the user at critical points of an auction, e.g., when another buyer has overbid the user's maximum price, especially in the closing minutes of an auction. One such alert may contain data indicating what auction the alert concerns, the latest bid amount in that auction, etc. Based on such an alert, the user may call the POAS to learn more details on the auction in question and/or instruct the information assistance provider to act on his/her behalf accordingly.

Like a contacts or appointments folder, a POAS folder for a user may be maintained by the information assistance service in association with an identifier of the user, e.g., the user's telephone number. Thus, in this particular illustrative embodiment, when an information assistance call is received, the subject service locates the folders associated with the caller based on an automatic number identification (ANI) associated with the call. As is well known, the ANI identifies the telephone number of the communications device from which the call originates. However, it should be noted that a user identification (ID), password, PIN, mother's maiden name, user voiceprint, etc. may be used in combination with, or in lieu of, an ANI to identify a user. For example, use of a voiceprint to identify a user is disclosed in copending, commonly assigned U.S. application Ser. No. 10/403,207 filed on Mar. 31, 2003, incorporated herein by reference.

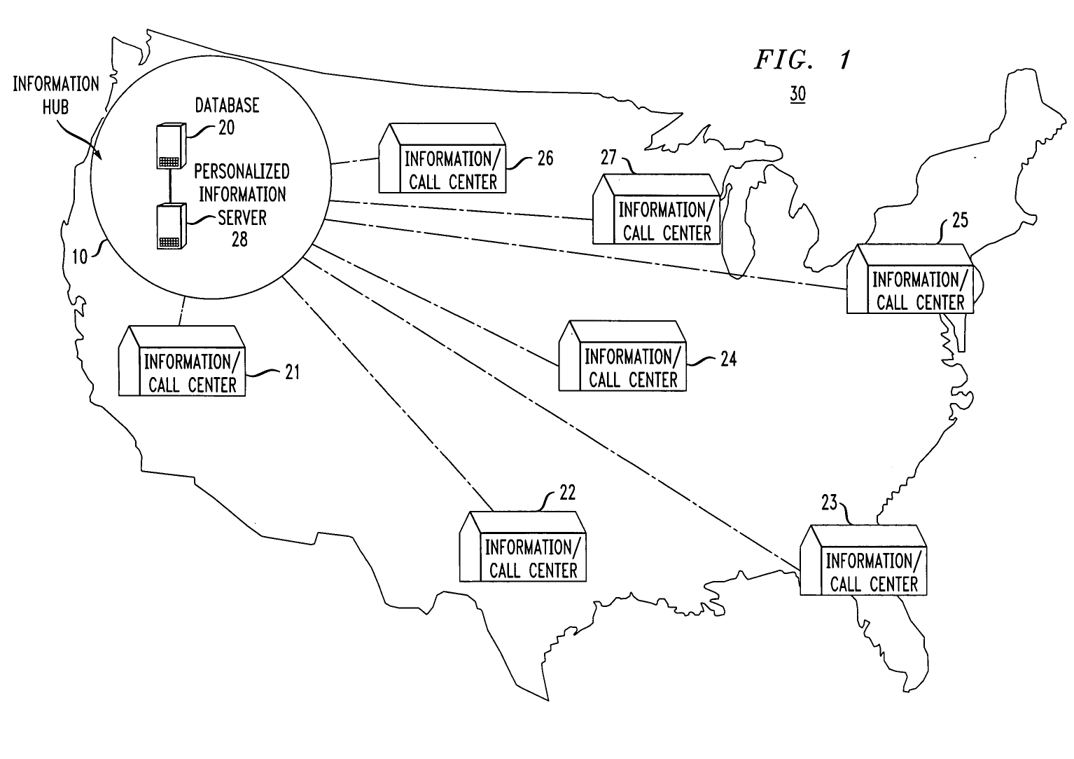

FIG. 1 illustrates a communications system for providing, inter alia, a personalized voice email service in accordance with the invention. This communication system includes wide area network (WAN) 30 covering an extensive area. WAN 30 may be an Internet-based network such as the World Wide Web or a private intrahet based network. WAN 30 connects operators dispersed throughout a wide coverage area in information/call centers 21 through 27. It should be noted that the term “operators” used herein broadly encompasses entities that are capable of providing assistance in a telecommunications environment, including without limitation human operators, voice response/recognition capabilities, web- /WAP-enabled operator services, and other automated and electronic access. One or more information hubs 10 are also included in WAN 30. An information hub 10 includes one or more personalized information servers 28 which are accessible by the operators in the system, and one or more databases 20 in which users' email, contacts, appointments and other folders may be stored and maintained. Such folders may also be stored locally at one or more of the information/call centers. The folders and information at different centers are synchronized. Synchronized databases provide necessary backup as well as support to roaming mobile device users.

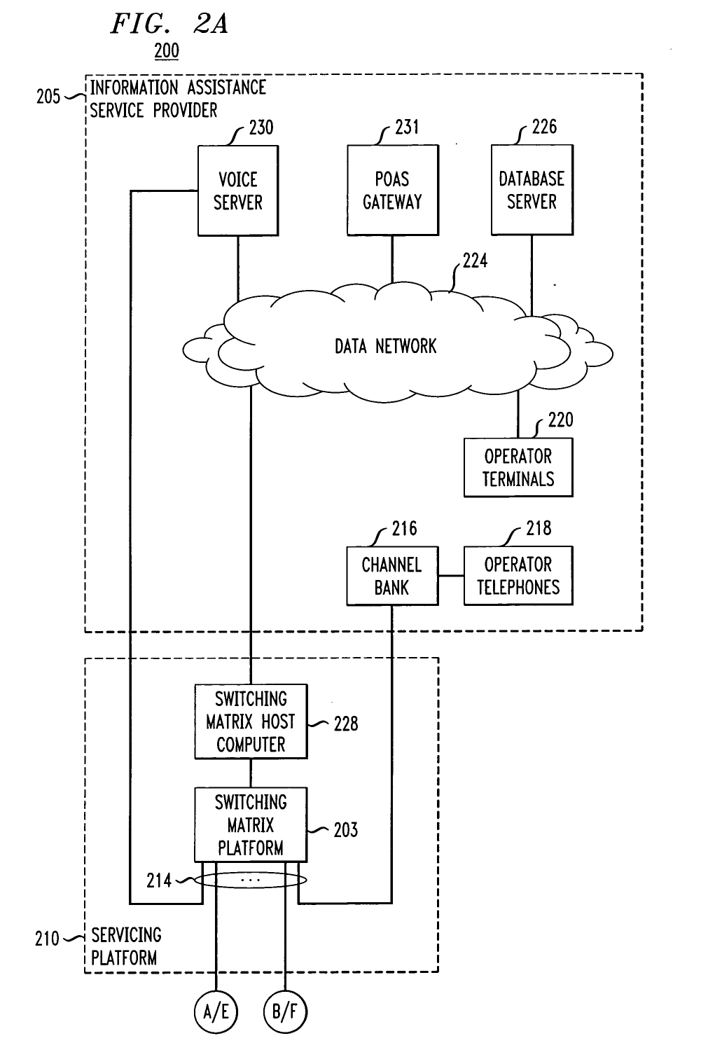

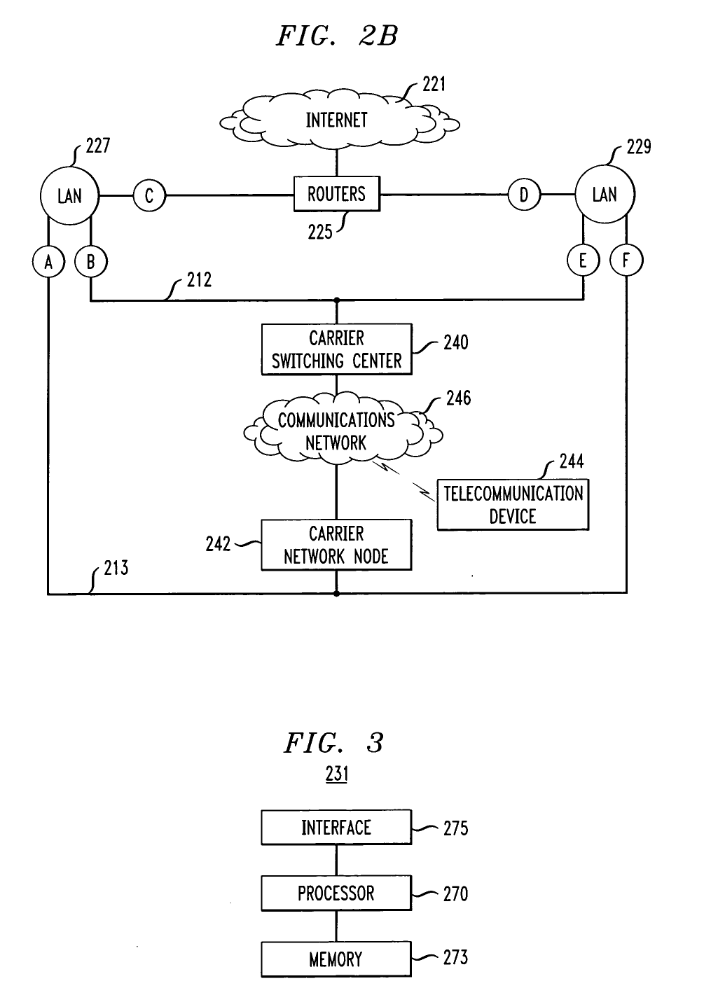

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 226 provides access to, among others, directory information from multiple sources. Database server 226 enables the operator to search directory information not just by name and address (sometimes city or area code) of a desired party, but also by type of goods/services and/or geographical region of a desired entity.

Data network 224 further connects to voice server 230, POAS gateway 231, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230 is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto. Voice server 230 is employed to play the constantly repeated parts of an operator's speech, including, for example, the caller's desired telephone number where requested, and possibly other information. At appropriate stages in a call progression, switch matrix host computer 228 initiates a voice path connection between voice server 30 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

FIG. 3 illustrates POAS gateway 231, which includes processor 270, memory 273 and interface 275. Instructed by software stored in memory 273, processor 270 is configured for communicating with online auction servers operated by various OASPs through interface 275 in accordance with a well known protocol(s) including, e.g., transmission control protocol/Internet protocol (TCP/IP). Interface 275 provides processor 270 with access to data network 224 and thence to Internet 221. For example, in response to signals from terminal 220, processor 270 may initiate Internet access and communicate with the online auction servers operated by such OASPs as eBay, Inc., Yahoo!, Inc., etc. Processor 270 transmits user logins (e.g., user IDs and passwords) from the user's POAS folder to the various online auction servers to log in to the user's accounts. In response, the servers provide any information including, e.g., a tracking list and bidding list of items, associated with the user accounts to gateway 231, which may then selectively transmit the received information to terminal 220 for presentation to a human operator who in turn conveys the same to the user, or to voice server 230 which communicates the same to the user in automated voice.

Users of a particular telephone carrier may dial, speak or otherwise communicate predetermined access digits, access codes or retail numbers, or input a predetermined address or a Uniform Resource Locator (URL) established for information assistance by that company. The instant example assumes that the user dials, e.g., “411,” “*555,”, “555-1212,” “1-800-555-1212,” “00,” or other designated access numbers. The participating telephone company's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes may be utilized, such as skills-based routing based on, e.g., a preferred call handling method specified by a user profile, or a priority scheme for preferred callers. The queue is maintained by switching matrix host computer 228.

To subscribe to the POAS, the user may call an operator at the designated access number. As part of the registration, the operator enters at a user data web page on server 28 user identifying information including username, password, and telephone number of the particular telecommunications device, e.g., a wireless telephone in this instance, which the user would use to call the information assistance service in the future. It is particularly advantageous to use such a phone number (also known as a mobile directory number (MDN) in the case of a wireless phone number) to identify the user since, as described before, the calling number would be automatically captured as an ANI at information/call center 200 when the user calls. Specifically, platform 214 in center 200 in a well-known manner derives the ANI from the call set-up signals associated with the user's call.

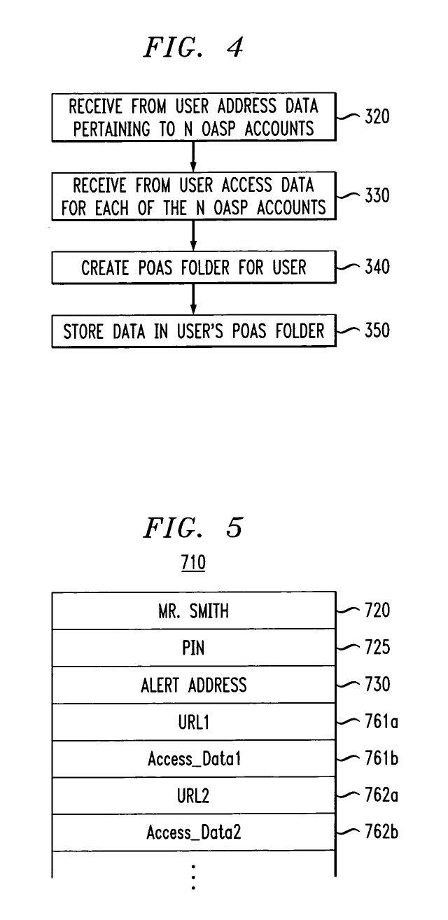

During the registration, the operator may also ask the user which online auction service accounts of his/hers are to be associated with the POAS. The user responds by identifying, say, N, OASP accounts, where N is an integer greater than or equal to one. Thus, as part of the registration, address data pertaining to the user's N OASP accounts is received from the user, as indicated at step 320 in FIG. 4. For example, the user may provide the uniform resource locators (URLs) of the online auction services, e.g., ebay.com, yahoo.com, etc., of which the user is a registered member. It may be necessary to prompt the user to provide sufficiently detailed information to enable POAS gateway 231 to access the specified online auction service accounts. For example, at step 330, the operator elicits and receives from the user access data for each of the N OASP accounts. Access data may include login information, e.g., a user ID, password, etc., associated with each online auction service account. At step 340, a POAS folder is created for the user in database 20. As mentioned before, such a POAS folder may be stored in databases 20, in association with the user's identification data (such as an ANI) for the user's access to his/her online auction service accounts. At step 350, the user's name (and other identifying information, if any), the URLs of the OASPs, and the online auction service account access data are stored in a record in the user's POAS folder.

FIG. 5 illustrates one such record 710 that may be maintained in an POAS folder of a hypothetical user named Mr. Smith. Record 710 comprises fields 720, 725, 730, 761a-b, 762a-b and 763a-b. In this example, field 720 contains Mr. Smith's name. Field 725 contains a personal identification number (PIN) or other identifying information selected by the user for verification of the user's identity when the user instructs an information assistance provider to place a bid in an auction on behalf of the user. Fields 761a and 761b respectively contain the URL (URL1) of Mr. Smith's first OASP and access data (Access_Data1) therefor provided by Mr. Smith. Fields 762a and 762b respectively contain the URL (URL2) of Mr. Smith's second OASP and access data (Access_Data2) therefor provided by Mr. Smith. It should be noted that although in this example, data for two OASP accounts is maintained in record 710, in alternative embodiments data for any number of OASP accounts may be maintained.

The operator may also ask the user if he/she wishes to specify an alert address(es), e.g., email address, SMS address, telephone number, etc., to which alerts are to be sent to the user at critical points of an auction. If the user specifies an alert address(es), such an address(es) is registered in field 730 of record 710.

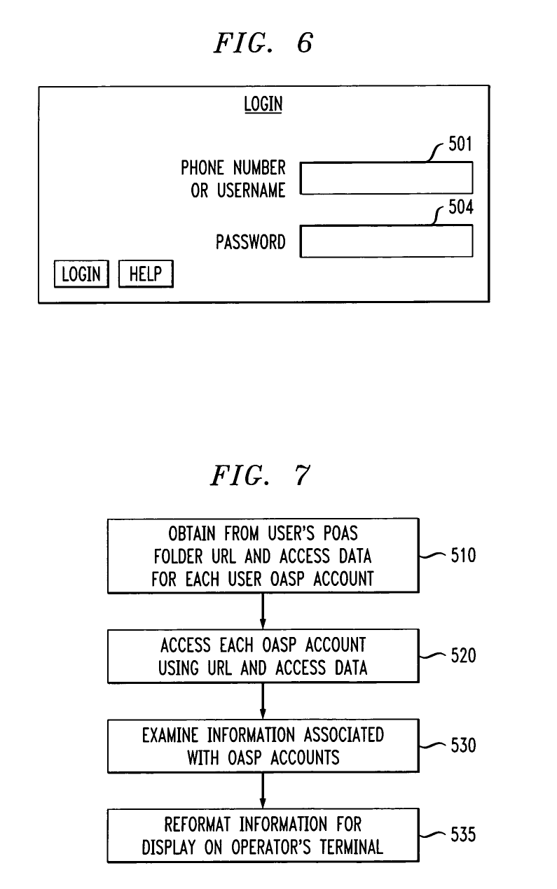

The user may subsequently use telecommunications device 244, e.g., a wireless phone, to call the information assistance service. Let's say the call is routed to information assistance/call center 200 where an operator attends to the call. After the user communicates his/her needs, e.g., to access the POAS, the operator at terminal 220 establishes communications with personalized information server 208 through WAN 30 (or alternatively Internet 221). In response, server 28 presents on terminal 220 a Login graphical user interface (GUI), which is illustrated in FIG. 6. As shown in FIG. 6, the operator is prompted to enter the user's phone number or username to identify the user, and a password to verify that the user is authorized to access the information assistance service. The ANI received from his/her communication device may be automatically provided in entry 501 of the Login GUI by server 28, thereby obviating the need of the operator's eliciting from the user, and entering, the required phone number or username. (In the event that such an ANI is not automatically available, or where the user is accessing the subject service from an unknown point or the operator suspects that the user calls from a phone number other than the registered phone number, the operator may verify/obtain the necessary identifying information with/from the user.) At entry 504, the operator enters the password provided by the user to complete the login process. The login information is then transmitted to server 28, where it checks the aforementioned user data web page to verify the received ANI and password. After they are verified, server 28 identifies the user's POAS folder based on the ANI. A copy of the user's POAS folder is provided to POAS gateway 231.

Let's suppose that Mr. Smith calls the information assistance service, and after his authorization is established, he asks the operator to tell him the statuses of each online auction in which he has been participating and/or tracking. The operator may select a predetermined option on the screen of terminal 220, and in response, gateway 231 uses the information in Mr. Smith's POAS folder, and in particular record 710 therein, to access his online auction service accounts. FIG. 7 is a flowchart depicting a routine for providing information pertaining to a user's OASP accounts, in accordance with one embodiment. At step 510, gateway 231 obtains from the POAS folder the URL and the access data listed therein for each user OASP account. In the illustrative example, gateway 231 examines, for example, fields 761 and 762 of record 710 and retrieves therefrom the URLs and access data for Mr. Smith's accounts with the respective OASPs. At step 520, gateway 231 accesses each of the OASP accounts using the URL and access data. Gateway 231 may communicate, via Internet 221, with the corresponding online auction servers at their respective URLs pursuant to a standard protocol.

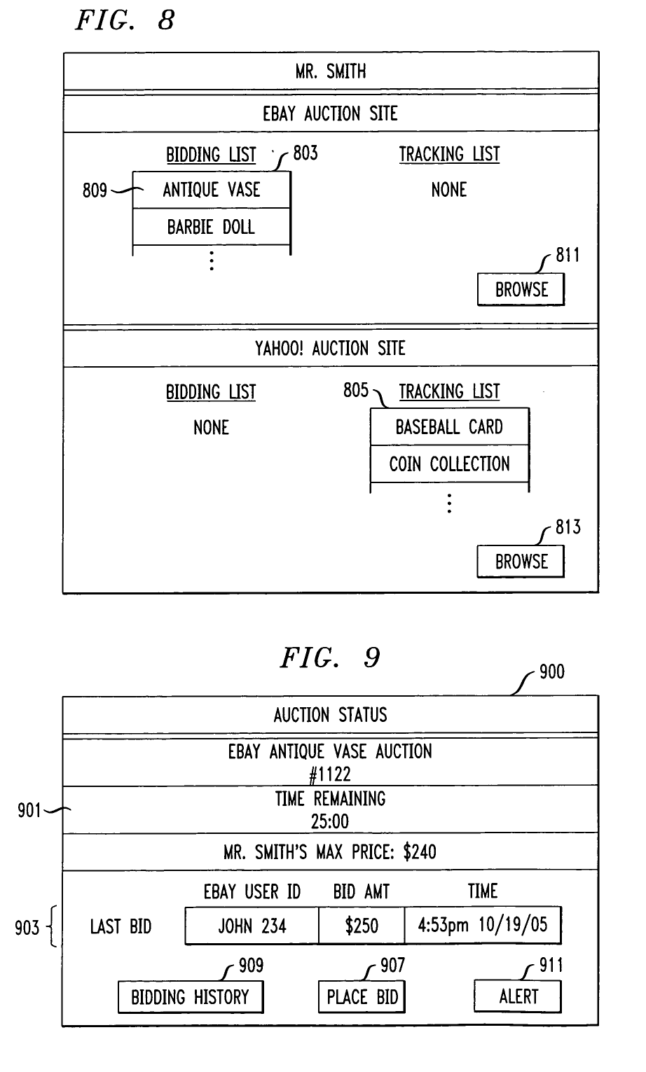

After accessing Mr. Smith's OASP accounts at URL1 and URL2, gateway 231 examines information associated with the OASP accounts which is received from the respective OASPs, as indicated at step 530. Gateway 231 at step 535 reformats the received information for display on operator terminal 220. FIG. 8 illustrates a Listing GUI for presentation on terminal 220, which in this instance includes bidding list 803 associated with Mr. Smith's account with eBay, and tracking list 805 associated with Mr. Smith's account with Yahoo!. For example, bidding list 803 includes items, e.g., an antique vase, a Barbie doll, etc., whose auctions are progressing at the eBay website in which Mr. Smith has been participating. Tracking list 805 includes items, e.g., a baseball card, a coin collection, etc. whose auctions are progressing at the Yahoo! website. Although Mr. Smith may be interested in acquiring the items on list 805, he has not participated in the auctions thereof. The Listing GUI also provides Browse options 811 and 813 for searching, on behalf of Mr. Smith, the respective websites for other items for auctions. Upon request by Mr. Smith, the operator may track, initiate or place a bid in an auction for any item desired by Mr. Smith. Any item for whose auction is tracked would be included in a tracking list, e.g., tracking list 805 for items from the Yahoo! auction site. Any item for which Mr. Smith participates in its auction would be included in a bidding list, e.g., bidding list 803 for items from the eBay auction site.

Continuing the example, Mr. Smith in this instance inquires about the status of the auction of the antique vase on bidding list 803. In response, the operator at terminal 220 selects (e.g., points and clicks at) antique vase item 809 on the list. Gateway 231 causes terminal 220 to show thereon an Auction Status GUI, denoted 900 in FIG. 9. As shown in FIG. 9, Auction Status GUI 900 identifies the antique vase auction in question, i.e., “eBay Antique Vase Auction #1122.” It also shows Time Remaining Indicator 901 for indicating the amount of time remaining in the auction, e.g., 25 minutes and 0 second. In this instance, Mr. Smith chose to bid for the antique vase by way of automatic bidding, where the maximum bidding price for the vase was previously specified by Mr. Smith, e.g., $240. In this example, GUI 900 includes Last Bid entry 903, indicating that the latest bid was submitted by a bidder by the eBay user ID of “John234” at 4:53 pm on 10/9/xx, whose amount is $250. The operator communicates the information in entry 903 to Mr. Smith.

It should be noted at this point that Mr. Smith's eBay user ID is not “John234.” Otherwise, gateway 231 would have translated it to “Mr.Smith” by matching the received eBay user ID from the eBay server with Mr. Smith's eBay user ID in entry 761b and by cross-referencing entry 720 of POAS record 710. It should also be noted that Time Remaining indicator 901 automatically keeps and counts down the remaining time initially received from the eBay server. By comparing Mr. Smith's maximum bidding price, i.e., $240 with the latest bid amount, i.e., $250, gateway 231 realizes that Mr. Smith has been overbid, and causes Place Bid option 907 to be highlighted, prompting the operator to elicit a higher bid from Mr. Smith. In an alternative embodiment, option 907 is highlighted when the competing bid is within a predetermined percentage of, but lower than, Mr. Smith's maximum price.

If Mr. Smith wants to place a higher bid or increase his maximum bidding price, the operator may select option 907 and submits the same information on behalf of Mr. Smith to the eBay server through gateway 231. In accordance with an aspect of the invention, the operator is authorized to place a bid for Mr. Smith only when Mr. Smith can produce the same PIN or other identifying information as that in field 725 of record 710. In addition, the POAS may keep a log of transactions in which Mr. Smith's identity is verified before a bid is placed for him.

Mr. Smith may want to learn the bidding history of the auction in question before he places a new bid. In that case, the operator may select Bidding History option 909 to retrieve from gateway 231 the last K bid entries, which may be shown on GUI 900 in a format similar to that of Last Bid Entry 903, where K represents a predetermined integer.

In accordance with another aspect of the invention, Mr. Smith may ask the operator to send him an alert from time to time which may contain the last bid amount in the auction in question. In that case, the operator may select alert option 911. Selection of option 911 enables the operator to further select one or more of the alert addresses specified in field 730 of record 710, to which one such alert is to be sent. The operator may further select for Mr. Smith the frequency of the alert, which may vary with the time remaining in the auction. For example, within 10 minutes of the closing of the auction, the alert frequency may be once every minute; and within 5 minutes of the closing thereof, the alert frequency may increase to once every 30 seconds. After receiving one such alert at his specified email address, SMS address and/or telephone number, Mr. Smith may want to contact the POAS to further participate the auction through an information assistance provider.

The foregoing merely illustrates the principles of the invention. It will thus be appreciated that those skilled in the art will be able to devise numerous other arrangements that embody the principles of the invention and are thus within the spirit and scope of the invention, which is defined by the claims below.

Finally, information/call center 200 and its components are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing information assistance, comprising:
storing data concerning access to one or more auction accounts associated with a user;
receiving a communication from the user through a first communications connection;
retrieving the data;
accessing the one or more auction accounts over a second communications connection;
providing, to the user, information associated with the one or more auction accounts; and
performing one or more operations with respect to an auction over the second communications connection on behalf of the user.

2. The method of claim 1, wherein the communication includes a telephone call.

3. The method of claim 2, wherein the first communications connection includes a telephonic connection.

4. The method of claim 1, wherein the second communications connection includes an Internet connection.

5. The method of claim 1, wherein the information concerns an auction item desired by the user.

6. The method of claim 1, wherein the one or more operations include placing a bid in the auction.

7. The method of claim 6, further comprising verifying the user's identity before the bid is placed.

8. The method of claim 1, further comprising generating a message to the user which concerns a status of the auction.

9. The method of claim 8, wherein the message contains a bid amount in the auction.

10. The method of claim 8, wherein a frequency of generating the message varies with remaining time of an auction.

11. A method for use by an information assistance provider, comprising:
storing first data concerning access to one or more auction accounts associated with a user, the first data being stored in association with second data representing the user;
receiving a communication from the user;
obtaining the second data during the communication;
retrieving the first data based on the second data;
using the first data to access the one or more auction accounts, established with one or more service providers which are unaffiliated with the information assistance provider; and
providing, to the user, information concerning the one or more auction accounts from the one or more service providers.

12. The method of claim 11, wherein the information assistance provider includes an operator.

13. The method of claim 11, wherein the information assistance provider includes a voice server.

14. The method of claim 11, wherein the communication includes a telephone call.

15. The method of claim 14, wherein the second data includes an automatic number identification (ANI).

16. The method of claim 11, wherein the second data includes a password.

17. The method of claim 11, wherein the second data includes a voiceprint.

18. The method of claim 11, wherein the information pertains to an auction of an item desired by the user.

19. The method of claim 18, further comprising placing a bid in the auction on behalf of the user.

20. The method of claim 19, further comprising verifying the user's identity before the bid is placed.

21. The method of claim 20, further comprising generating a message to the user which concerns a status of the auction.

22. The method of claim 21, wherein the message contains a bid amount in the auction.

23. The method of claim 21, wherein a frequency of generating the message varies with remaining time of an auction.

24. A system for providing information assistance, comprising:
storage for storing data concerning access to one or more auction accounts associated with a user;
an interface for receiving a communication from the user through a first communications connection, the data being retrieved from the storage; and
a processor configured for accessing the one or more auction accounts over a second communications connection, the user being provided with information associated with the one or more auction accounts, one or more operations being performed with respect to an auction over the second communications connection on behalf of the user.

25. The system of claim 24, wherein the communication includes a telephone call.

26. The system of claim 25, wherein the first communications connection includes a telephonic connection.

27. The system of claim 24, wherein the second communications connection includes an Internet connection.

28. The system of claim 24, wherein the information concerns an auction item desired by the user.

29. The system of claim 24, wherein the one or more operations include placing a bid in the auction.

30. The system of claim 29, wherein the user's identity is verified before the bid is placed.

31. The system of claim 24, wherein a message to the user is generated which concerns a status of the auction.

32. The system of claim 31, wherein the message co ntains a bid amount in the auction.

33. The system of claim 31, wherein a frequency of generating the message varies with remaining time of an auction.

34. A system for use by an information assistance provider, comprising:
storage for storing first data concerning access to one or more auction accounts associated with a user, the first data being stored in association with second data representing the user;
an interface for receiving a communication from the user, the second data being obtained during the communication; and
a processor configured for retrieving the first data based on the second data, the first data being used to access the one or more auction accounts, established with one or more service providers which are unaffiliated with the information assistance provider, the user being provided with information concerning the one or more auction accounts from the one or more service providers.

35. The system of claim 34, wherein the information assistance provider includes an operator.

36. The system of claim 34, wherein the information assistance provider includes a voice server.

37. The system of claim 34, wherein the communication includes a telephone call.

38. The system of claim 37, wherein the second data includes a ANI.

39. The system of claim 34, wherein the second data includes a password.

40. The system of claim 34, wherein the second data includes a voiceprint.

41. The system of claim 34, wherein the information pertains to an auction of an item desired by the user.

42. The system of claim 41, wherein a bid is placed in the auction on behalf of the user.

43. The system of claim 42, wherein the user's identity is verified before the bid is placed.

44. The system of claim 43, a message to the user is generated which concerns a status of the auction.

45. The system of claim 44, wherein the message contains a bid amount in the auction.

46. The system of claim 44, wherein a frequency of generating the message varies with remaining time of an auction.
